(19) United States
(12) Patent Application Publication
(10) Pub. No.: US 2009/0192068 A1
(43) Pub. Date: Jul. 30, 2009

(54) Method for producing essential oil emulsion

(76) Inventors: Tomohiko Ogasawara, Kanagawa (JP); Teruyoshi Yamaguchi, Tokyo (JP)

Correspondence Address: Fildes & Outland, 20916 Mack Avenue, ste. 2, Grosse Pointe Woods, MI, 48236, US

(21) Appl. No.: 10/585,894

(22) PCT Filed: Dec. 24, 2004
(86) PCT No.: PCT/JP2004/019398

§ 371 Date: Jul. 11, 2006

(30) Foreign Application Priority Data
Jan. 16, 2004 (JP) 2004-009024

(51) Int. Cl. C11D 17/08

(52) U.S. Cl. 510/417

(57) ABSTRACT

There is provided a method for producing an essential oil emulsion without using a surfactant, wherein the essential oil emulsion can be easily diluted with water for its use and its emulsified state is stable, wherein the production method is characterized in that it comprises stirring an essential oil at a rotation number between 3,000 and 20,000 rpm in an alkaline solution with a pH value between 9 and 13 for emulsification, wherein the alkaline solution is either an aqueous solution of a compound (a base) that is dissolved in water to generate hydroxide ions (OH⁻), or an alkaline ionized water generated on the cathode side (on the negative electrode side) when an electrolyte solution containing an electrolyte is decomposed by electrical energy, wherein the aqueous solution preferably has a base concentration between 0.00001 N and 0.01 N and a pH value between pH 9 and 13.

### TECHNICAL FIELD

The present invention relates to a technique of producing an emulsion, which is neither separated nor precipitated, from a water-insoluble essential oil, without depending on addition of emulsifiers such as a synthetic surfactant.

Previously, synthetic surfactants such as a linear alkylbenzene sulfonate (hereinafter referred to as LAS) or soaps produced by saponification of fatty acid have been generally used as detergents used for washing. However, there has been a fear that the use of a large amount of such a synthetic surfactant or soap affects the users or the environment. Thus, a detergent with low environmental load and high safety has been desired.

### BACKGROUND ART

In order to solve the aforementioned problems, Patent Document 1 discloses a detergent produced by mixing an essential oil such as limonene having a high washing effect on fat-soluble soil, which contains a small amount of surfactant.

Since such an essential oil is water-insoluble, a detergent that contains an essential oil such as limonene should comprise surfactants such as a nonionic, anionic, cationic, or bipolar surfactant. Thus, such a detergent has been designed to be water-soluble or be emulsified.

Patent Document 1 discloses that 0.1% to 5.0% by weight of essential oil is solubilized by the use of 3.0% to 20.0% by weight of surfactant. In addition, the above document also discloses that the pH thereof is set around neutral, so that the obtained product can be an environmentally-sound detergent.

Patent Document 2 discloses that the amount of a surfactant that does not affect plants is set at 2% or less.

It is thought that synthetic surfactants such as LAS have low toxicity to humans and have high biodegradability. However, such synthetic surfactants may be chemically reacted with other surfactants and they thereby change to substances with high toxicity, such as a LAS complex. Thus, the safety of such synthetic surfactants cannot be guaranteed under the environment wherein various types of surfactants are used and discharged. As a result, concerns about new serious damage are rising.

It is said that a soap, which is a salt of a weakly acidic fatty acid with a weak base, becomes a smaller load on the environment than a synthetic surfactant. However, as shown in the following formula (1), when such a soap is dissolved in water, a portion thereof hydrolyzes, so as to generate a fatty acid. As shown in the following formulas (2) and (3), this fatty acid binds to a soap or calcium, so as to produce a water-insoluble acid soap or metallic soap. Such an acid soap or metallic soap has been generally known as soap scum, which is fixed soil found in various places in a bathroom, such as a bathtub, a basin, or a mirror. Invisible water pipes are also contaminated by such soap scum, and thus, soap scum causing the clogging of pipes is acknowledged as a problem.

RCOONa+H₂O→RCOOH+Na⁺+OH⁻ (1)

soap water fatty acid

RCOOH+RCOONa→RCOOH/RCOONa (2)

fatty acid soap acid soap (water-insoluble)

2RCOONa+Ca²⁺→(RCOO)₂Ca+2Na⁺ (3)

soap (water-soluble) calcium soap (water-insoluble)

Examples of the essential oil used in the present invention may include an apple oil, an orange oil, a peppermint oil, a lemon oil, and a rose oil. These essential oils are composed of a group of organic compounds having various properties such as aromatic incense, volatility, or fat-solubility, contained in plant flowers, leaves, pericarps, barks, and the like. Since such an essential oil differs from oils and fats such as an olive oil or a soybean oil and has favorable flavor and beneficial effects, it is also referred to as an essential oil or aromatherapy oil in the field of foods and pharmaceuticals. An essential oil is compatible with oil, and thus it has a high detergency for grease. However, since such an essential oil is hardly mixed with water, it is mainly used as perfume.

### Patent Document 1: Japanese Patent Laid-Open Publication No. 2000-096091

### Patent Document 2: Japanese Patent Laid-Open Publication No. 2002-154910 (pp. 2-3)

### DISCLOSURE OF THE INVENTION

### Problems to be Solved by the Invention

Taking into consideration the aforementioned problems, the present invention has been made. The present invention provides a method for producing an essential oil emulsion, using no chemical agents such as synthetic surfactants or organic solvents, which may have a risk of causing health damage, wherein the above production method enables emulsification of water and an essential oil at any given ratio and the obtained essential oil emulsion is in a stable emulsified state.

### Means for Solving the Problems

The present invention relates to a method for producing an essential oil emulsion, which is characterized in that it comprises stirring an essential oil at a rotation number between 3,000 and 20,000 rpm in an alkaline solution at pH 9-13, to produce an emulsion. The alkaline solution may be either an aqueous solution of a compound (a base) that is dissolved in water to generate hydroxide ions (OH⁻), or an alkaline ionized water generated on the cathode (negative electrode) side when water is decomposed by electrical energy.

The aqueous solution of a basic compound is characterized in that it has a base concentration between 0.00001 N and 0.1 N and a pH value between 9 and 13.

The alkaline ionized water is characterized in that it preferably has a pH value between 9.5 and 12.5.

The alkaline ionized water is characterized in that when it is generated via electrolysis, a ceramic produced from a soil comprising minerals is used as a diaphragm for separating the cathode side from the anode side, so that the water contains ionized minerals.

### ADVANTAGES OF THE INVENTION

An alkaline solution has a strong detergency for aqueous soil, but a poor detergency for grease. On the other hand, an essential oil has a strong detergency for grease because of its high affinity for oil, but it has no detergency for aqueous soil. Thus, when both components complement each other to overcome their disadvantages, the versatility as a detergent is enhanced.

In the present invention, an optimal detergency for washing out different types of soil, such as fat-soluble soil and water-soluble soil, can be attained by arbitrary control.

The essential oil emulsion of the present invention does not contain synthetic surfactants that affect the ecology or human bodies.

The essential oil emulsion of the present invention can be easily diluted with water, without using surfactants that affect plants.

In addition, the essential oil emulsion of the present invention stabilizes an essential oil for a long period of time and maintains the emulsified state thereof. Moreover, a liquid obtained by dilution of the essential oil emulsion with water maintains an emulsified state for a long period of time.

### BEST MODE FOR CARRYING OUT THE INVENTION

The type of an essential oil used for the essential oil emulsion of the present invention is not particularly limited. Taking into consideration environmental load, it is desired to use a plant essential oil with high safety.

In addition, an essential oil produced by disintegrating the organ as a whole of a plant, such as flowers, leaves, pericarps, barks, seeds, woods, roots, and pedicles, via mechanical means, and then extracting the essential oil by various types of extraction methods, can be used.

Various types of extraction methods used in the present invention include compression extraction, hydrophobic solvent extraction, hydrothermal extraction, steam extraction, oil and fat adsorption, liquefied gas extraction, supercritical extraction, and a combined use thereof. With regard to the thus extracted essential oil, the production cost can be reduced.

Such an essential oil is water-insoluble. Thus, in order to change such an essential oil to a usable liquid by dilution with water, it is mechanically microparticulated via stirring, so as to convert it to an emulsified state. During this operation, the present invention is characterized in that water with alkaline property is used.

Herein, an aqueous solution of a basic compound can be used as an alkaline solution. However, alkaline ionized water produced by electrolysis is most preferably used.

Such alkaline ionized water has strong antimicrobial activity at pH 9.5 or greater. Hydroxy ions contained in such alkaline ionized water exhibit an excellent washing effect. In addition, an essential oil has effects such as a relaxing effect, a refreshing effect, and sedative action, as well as insect-repellent, antibacterial, and deodorant effects, depending on the type. Accordingly, several functions are selected from them, and an essential oil with such functions can be used as a detergent having any given effect.

When plant saponin extracted from soybeans, felon herb, tea leaves, or the like, is added to the essential oil emulsion of the present invention, its washing effect is improved, and soil is floated out by bubbles, for example.

When a polysaccharide thickener with high moisture retention property derived from plants, such as pectin or xanthan gum, is added to the essential oil emulsion of the present invention, the surface of dried soil becomes softened, and thus it is easily washed out.

When plant wax such as yellow beeswax or Japan wax is added to the essential oil emulsion of the present invention, the strong perfume of an essential oil can be reduced.

In the present invention, an alkaline solution stabilizes the emulsified state of an essential oil emulsion, and when an essential oil is used for purposes such as insect proofing or antibacterial action, the operation to dilute the essential oil emulsion with water can be smoothly carried out. This alkaline solution preferably has a pH of 11 or greater.

If the pH of the alkaline solution is less than 9, its emulsifying action cannot be exhibited. If the pH is less than 11, the emulsified essential oil may be separated several days (4 to 8 days) later when the stirring rate is 12,000 rpm or less for emulsification.

Moreover, if such stirring operation is carried out at a high speed, an essential oil may be deteriorated due to friction heat. Accordingly, if possible, it is desired to carry out emulsification via slow rotation for a short time. Furthermore, such stirring is preferably carried out under cooling.

For stirring, common emulsification and dispersion devices such as a stirring homogenizer, a media mill, a roll mill, or a high-pressure homogenizer, can be used. Depending on the performance of such an emulsification and dispersion device, it is desired that a stirring rate, a stirring time, a pressure, and a temperature be controlled to the optimal conditions, and that the particle size of an essential oil be set at a mean particle size between approximately 0.2 and 2.0 μm.

Further, as the pH of the aforementioned alkaline solution increases, the emulsified essential oil may be changed in color. This is because of quercetin contained in the essential oil as a plant extract. Thus, such change in color does not cause any problems regarding use.

### EXAMPLES

The present invention will be further specifically described in the following examples. However, these examples are not intended to limit the scope of the present invention.

Materials, devices, and the like, which were used in the examples, will be described below: (1) Essential oil: Lemon oil manufactured by Nippon Flavour Kogyo Co., Ltd. was used. (2) Alkaline ionized water: A flat ceramic diaphragm was sandwiched between the anode and the cathode. Deionized water that contained 10% by weight of common salt was injected into the anode tank, and deionized water was injected into the cathode tank, followed by application of electric current. Thereafter, alkaline ionized waters with various pH values obtained in the cathode tank after completion of the energization were used.

(3) Stirring device: Cleamix CLM-0.8S (screen S1.0-24; rotor R4), manufactured by EMTEC Co., Ltd.

### Example 1

50 g of the aforementioned essential oil (1) and 50 g of the aforementioned alkaline ionized water with pH 9.0 were poured into the aforementioned stirring device (3). Thereafter, the obtained mixture was stirred at a temperature between 5° C. and 10° C. and at a rotation number of 20,000 (r.p.m) for 2 minutes, so as to obtain a light yellow white emulsion. The obtained essential oil emulsion was conserved in a closed container at 25° C. for 90 days. However, the properties of the emulsion were not changed.

### Examples 2-5

Essential oil emulsions were obtained in the same manner as in Example 1, with the exceptions that the pH value of the alkaline ionized water was changed as shown in Table 1, and that the rotation number of the stirring device was changed as shown in Table 1.

As shown in Table 1, the properties of the obtained essential oil emulsions were favorable.

### Comparative Example 1

An essential oil emulsion was obtained in the same manner as in Example 1, with the exception that the pH of the alkaline ionized water was set at pH 8.6.

As a result, the essential oil was separated from the ionized alkaline water, and no essential oil emulsions were obtained.

### Comparative Example 2

An essential oil emulsion was obtained in the same manner as in Example 1, with the exception that the pH of the alkaline ionized water was set at pH 13.3.

As a result, an essential oil emulsion was obtained, but its yellow color was stronger than that of the emulsion obtained in Example 1.

TABLE 1

| | | Examples | | | | | Comparative examples | |
|---|---|---|---|---|---|---|---|---|
| | | 1 | 2 | 3 | 4 | 5 | 1 | 2 |
| Essential oil | | 50 g | 50 g | 50 g | 50 g | 50 g | 50 g | 50 g |
| Alkaline | pH 8.6 | — | — | — | — | — | 50 g | — |
| ionized water | pH 9.0 | 50 g | — | — | — | — | — | — |
| | pH 9.5 | — | 50 g | — | — | — | — | — |
| | pH 10.1 | — | — | 50 g | — | — | — | — |
| | pH 11.2 | — | — | — | 50 g | — | — | — |
| | pH 12.5 | — | — | — | — | 50 g | — | — |
| | pH 13.3 | — | — | — | — | — | — | 50 g |
| Stirring conditions | | | | | | | | |
| Rotation | | 20,000 | 15,000 | 15,000 | 12,000 | 8,000 | 20,000 | 8,000 |
| number(r.p.m.) | | | | | | | | |
| Stirring time | | 2 | 2 | 2 | 2 | 2 | 2 | 2 |
| (min.) | | | | | | | | |
| Temperature (° C.) | | 5 to 10 | 5 to 10 | 5 to 10 | 5 to 10 | 5 to 10 | 5 to 10 | 5 to 10 |
| Emulsified | Zero | Emulsified | Same as | Same as | Same as | Same as | Separated | Emulsified |
| state | hour | and changed | on the | on the | on the | on the | | and changed |
| (Conserved in | later | into pale | left | left | left | left | | into yellow |
| a closed | | yellow white | | | | | | white color |
| vessel at 25° C.) | | color | | | | | | |
| | 4 days | Same as | Same as | Same as | Same as | Same as | — | Same as |
| | later | above | above | above | above | above | | above |
| | 5 days | Same as | Same as | Same as | Same as | Same as | — | Same as |
| | later | above | above | above | above | above | | above |
| | 8 days | Same as | Same as | Same as | Same as | Same as | — | Same as |
| | later | above | above | above | above | above | | above |
| | 90 days | Same as | Same as | Same as | Same as | Same as | — | Same as |
| | later | above | above | above | above | above | | above |

### INDUSTRIAL APPLICABILITY

In the embodiments of the present invention, the best mode for using an essential oil emulsion for washing is described. Such an essential oil emulsion can be used to repel animals such as a dog, a cat, a mouse, or a bird, and in particular, to prevent the devastation of dusts by crows, or can also be used as an insecticide, a germicide, or a fungicide.

1. A method for producing an essential oil emulsion, characterized in that the method comprises stirring an essential oil at a rotation number between 3,000 and 20,000 rpm in an alkaline solution with a pH value between 9 and 13, to produce an emulsion.

2. The method for producing an essential oil emulsion according to claim 1, wherein the alkaline solution is either an aqueous solution of a basic compound that is dissolved in water to generate hydroxide ions (OH⁻), or an alkaline ionized water generated on the cathode side when an electrolyte solution containing an electrolyte is decomposed by electrical energy.

3. The method for producing an essential oil emulsion according to claim 2, wherein the aqueous solution of a basic compound has a base concentration between 0.00001 N and 0.1 N and a pH value between 9 and 13.

4. The method for producing an essential oil emulsion according to claim 2, wherein the alkaline ionized water has a pH value between 9.5 and 12.5.

5. The method for producing an essential oil emulsion according to claim 2, wherein when the ionized alkaline water is generated via electrolysis, a ceramic produced from a soil containing minerals is used as a diaphragm for separating the cathode side from the anode side, so that the alkaline ionized water contains ionized minerals.

6. The method for producing an essential oil emulsion according to claim 4, wherein when the ionized alkaline water is generated via electrolysis, a ceramic produced from a soil containing minerals is used as a diaphragm for separating the cathode side from the anode side, so that the alkaline ionized water contains ionized minerals.
